(19) United States
(12) Patent Application Publication
(10) Pub. No.: US 2014/0010273 A1
(43) Pub. Date: Jan. 9, 2014

(54) IMPULSE NOISE MEASUREMENT BY SPECTRAL DETECTION

(71) Applicants: Rabah Tarafi, Lannion (FR); Alain Cario, Lannion (FR)

(72) Inventors: Rabah Tarafi, Lannion (FR); Alain Cario, Lannion (FR)

(73) Assignee: France Telecom, Paris (FR)

(21) Appl. No.: 13/996,365

(22) PCT Filed: Dec. 19, 2011
(86) PCT No.: PCT/FR2011/053059

§ 371 Date: Sep. 19, 2013

(30) Foreign Application Priority Data
Dec. 20, 2010 (FR) 1060820

(51) Int. Cl. H04B 3/46

(52) U.S. Cl. CPC H04B 3/46
USPC 375/224

(57) ABSTRACT

A method and device are provided for measuring impulse noise in a signal. The method includes: measuring at least one first signal; converting the first signal in the frequency domain; defining a variable-frequency triggering threshold on the basis of stationary characteristics of the first signal; measuring a second signal; converting the second signal in the frequency domain; storing the second signal when the second signal reaches or passes the triggering threshold; and high-pass-filtering the stored signal.

### CROSS-REFERENCE TO RELATED APPLICATIONS

This Application is a Section 371 National Stage Application of International Application No. PCT/FR2011/053059, filed Dec. 19, 2011, which is incorporated by reference in its entirety and published as WO 2012/085431 on Jun. 28, 2012, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the invention is that of digital telecommunications.

### BACKGROUND OF THE DISCLOSURE

Communication systems may be subjected to high-power electromagnetic interference. The noise generated by electromagnetic interference may be classed into two broad categories: stationary noise and impulse noise.

The fundamentally different measurement methods for each of these categories of interference are tailored to the stationary or transient nature of the electromagnetic interference.

Thus, a swept spectrum analyzer is generally used to study stationary noise and a digital oscilloscope is generally used to study impulse noise.

To measure stationary noise, a spectrum analyzer is conventionally used to carry out a sweep of the entire spectrum to be monitored.

Over a relatively long timescale, typically of the order of a second, the spectrum analyzer sweeps these frequencies in order to obtain the spectral power density of the noise over the entire spectrum.

In this operating mode, the spectrum analyzer has a very high sensitivity and a very low internal noise level. These two characteristics make it very suitable for measuring stationary interference on phone lines, with sometimes very low levels.

In addition, impulse noises are characterized by what may be very high amplitudes but above all by their very brief duration. Isolated impulse noises may for example last a few microseconds.

Swept spectrum analyzers are not suitable for observing effects that vary over time. Specifically, if the overall spectral power density of the noise is to be measured, it must not change during the time it takes the analyzer to complete a sweep. Analysis of an impulse noise, which is a particularly transient effect, is therefore impossible: the duration of an impulse noise is very much smaller than the duration of a sweep (a few μs versus several ms).

In contrast, the digital oscilloscope is a tool used to measure transient effects, allowing variations in the signal to be observed as a function of time, using various triggers and storing signals in memory. It is for this reason that it is used to measure impulse noise.

To do this, a triggering threshold for capturing signals to memory is defined. When the amplitude of a signal exceeds this threshold, the signal is stored in memory and then processed. Noises are measured as a function of time. The processing required to find out their duration and their amplitude can therefore be carried out directly.

However, the threshold must necessarily be above the amplitude of the stationary noise. This implies that impulse noises the amplitude of which is smaller than that of the stationary noise cannot be measured using this method.

Impulse noises adversely affect xDSL or PLT (power line transmission) transmissions, for example—i.e. transmissions for which the frequency characteristics of the transmitted signal must be known and controlled to ensure good reception of the signal.

### SUMMARY

An exemplary embodiment of the present invention provides a method for measuring impulse noise in a signal, characterized in that it comprises steps of:

measuring at least one first signal;

transforming the first signal into the frequency domain;

defining a triggering threshold that varies as a function of frequency, depending on the stationary characteristics of the first signal;

measuring a second signal;

transforming the second signal into the frequency domain;

storing the second signal in memory when the second signal reaches or exceeds the triggering threshold; and

high-pass filtering the stored signal.

By virtue of the invention, an impulse noise may be measured in a signal comprising stationary noise even if the impulse noise has an amplitude smaller than that of the stationary noise. The measurement of such impulse noises is particularly important for transmissions for which the frequency characteristics of the transmitted signal must be known and controlled in order to ensure good reception of the signal. It will be noted that the triggering threshold is defined in the frequency domain.

According to one preferred feature, the transformation of the signal into the frequency domain is carried out via a Fourier transform. A fast Fourier transform may especially be used.

According to another preferred feature, the transformation of the signal into the frequency domain is carried out in a real-time spectrum analyzer. Real-time spectrum analyzers are particularly suitable for transforming signals into the frequency domain.

According to another preferred feature, the triggering threshold is defined from a measurement of stationary noise in the first signal. Thus, the triggering threshold is tailored to the signal processed. If the processed signal contains only stationary noise, the triggering threshold is not exceeded and impulse noise is not detected. In contrast, once the triggering threshold is reached, this indicates the presence of an impulse noise and processing of the signal is carried out in order to measure this impulse noise.

According to another preferred feature, the triggering threshold is a mask placed over the first signal. Thus, the triggering is obtained in a relatively simple way by comparing the second signal with the mask in the frequency domain.

According to another preferred feature, a plurality of first signals is measured and transformed into the frequency domain, the triggering threshold that varies as a function of frequency then being defined depending on the average of the plurality of transformed first signals.

The invention also relates to a device for measuring impulse noise in a signal, characterized in that it comprises:

means (AS) for transforming the signal into the frequency domain, the transforming means being able to measure at least one first signal and one second signal;

means for defining a triggering threshold that varies as a function of frequency, depending on stationary characteristics of the first signal;

means for storing the second signal in memory when the triggering threshold is reached or exceeded; and

means for high-pass filtering the stored signal.

This device has analogous advantages to those of the method described above.

In a particular embodiment, the various steps of the methods according to the invention are defined by computer program instructions.

Therefore, the invention also relates to a computer program stored on a data carrier, this program being capable of being executed by a computer, this program comprising instructions for carrying out the steps of a method such as described above.

This program may be written in any programming language and may take the form of source code, object code or an intermediate code between source and object code, such as code in a partially compiled form or in any other desirable form.

The invention also relates to a computer-readable data carrier comprising computer program instructions such as mentioned above.

The data carrier may be any entity or device capable of storing the program. For example, the carrier made comprise a storage means, such as a ROM, for example a CD ROM or a microelectronic ROM circuit, or even a magnetic recording means, for example a floppy disk or a hard drive.

Furthermore, the data carrier may be a transmissible carrier such as an electrical or optical signal that may be transferred via an electrical cable or optical fiber, by radio or by other means. The program according to the invention may in particular be downloaded from a network such as the Internet.

Alternatively, the data carrier maybe an integrated circuit in which the program is incorporated, the circuit being able to execute the method in question or to be employed in its execution.

### BRIEF DESCRIPTION OF THE DRAWINGS

Other features and advantages will become apparent on reading about an embodiment described with reference to the figures, in which:

FIG. 1 shows an embodiment of the measuring method according to the invention;

FIG. 2 shows an example of a signal to be processed according to the invention, in the time domain;

FIG. 3 shows the same example of a signal to be processed according to the invention, in the frequency domain;

FIG. 4 shows the signal during processing according to the invention, in the frequency domain;

FIG. 5 shows an embodiment of a step in the method according to the invention;

FIG. 6 shows the impulse noise signal determined according to the invention; and

FIG. 7 shows an embodiment of a measuring device according to the invention.

### DETAILED DESCRIPTION OF ILLUSTRATIVE EMBODIMENTS

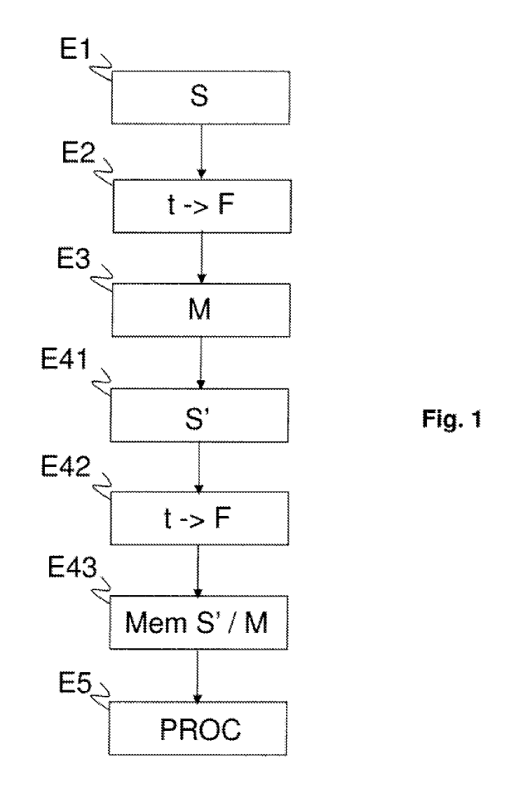

According to one embodiment of the invention shown in FIG. 1, the method for measuring impulse noise in a signal S comprises the steps E1 to E5.

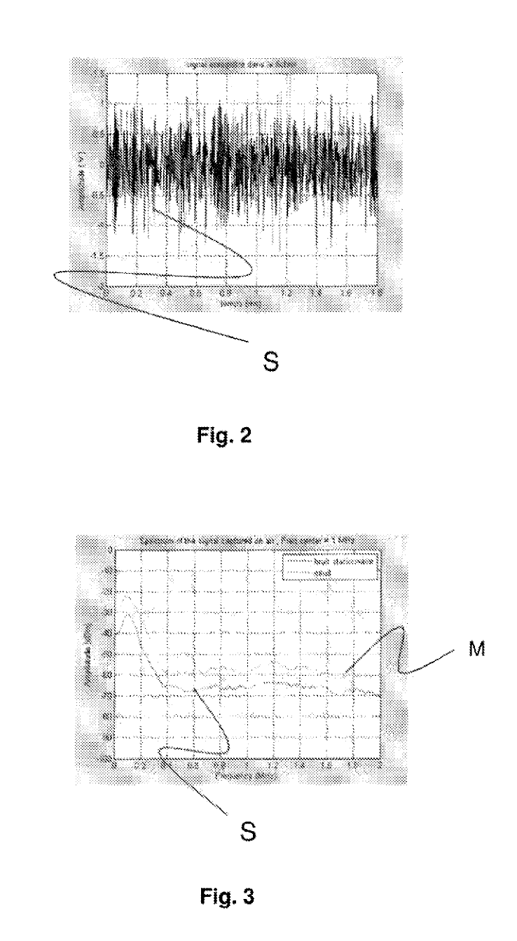

Step E1 is the measurement of at least one first signal S by a real-time spectrum analyzer. This first signal S is shown in the time domain in FIG. 2. It contains stationary noise and is liable to contain impulse noise. The stationary characteristics of the signal are known. In particular, the first signal S in FIG. 2 contains only stationary noise in a preferred embodiment.

In order to illustrate the invention, only one first signal S is indicated as being measured in this step, but a plurality of first signals S may also be measured, for example by carrying out a number of acquisitions in succession by means of the real-time spectrum analyzer.

The following step E2 is the transformation of the first signal S into the frequency domain, for example by applying a fast Fourier transform (FFT). FIG. 3 shows the first signal S after transformation into the frequency domain. It may be seen that the amplitude of the first signal S is higher at low frequencies than at higher frequencies.

When a plurality of first signals S has been measured, they are all transformed into the frequency domain in this step.

The following step E3 is the definition of a triggering threshold, in the frequency domain, depending on the stationary characteristics of the signal. In particular, this triggering threshold varies as a function of frequency in order to take into account the stationary characteristics of the signal.

For this purpose, a frequency-domain mask M is defined, the amplitude of which is located above that of the first signal S.

When a plurality of first signals S has been measured and transformed into the frequency domain, this triggering threshold that varies as a function of frequency is defined depending on these first signals S, for example depending on the average of these first signals S. Thus, the aforementioned frequency-domain mask M may be defined with an amplitude above that of the average of these first signals S.

It is now assumed that an impulse noise is present in a second signal S′ to be analyzed. This second signal S′ to be analyzed thus contains stationary noise, analogous to that in the first signal S, and impulse noise. The impulse noise has a smaller amplitude than that of the stationary noise, so that the time-domain representation of the second signal S′ is analogous to that of the first signal S (FIG. 2). The impulse noise is not directly detectable in the time domain and is in some respects hidden in the stationary noise.

In this case, steps E41 to E43 are implemented:

the second signal S′ is measured (step E41) by a real-time spectrum analyzer, similarly to the aforementioned step E1;

this second signal S′ is then transformed into the frequency domain (step E42), similarly to the aforementioned step E2, for example by applying a fast Fourier transform (FFT); and

lastly, the second signal S′ is stored in memory if the noise level measured reaches or exceeds the frequency-domain mask M (step E43), thereby resulting in a stored signal S″ being obtained, which signal has frequency components only in certain portions of the spectrum. The capture to memory is therefore based on a frequency-domain analysis of the second processed signal S′. The stored signal S″ is stored in the time domain.

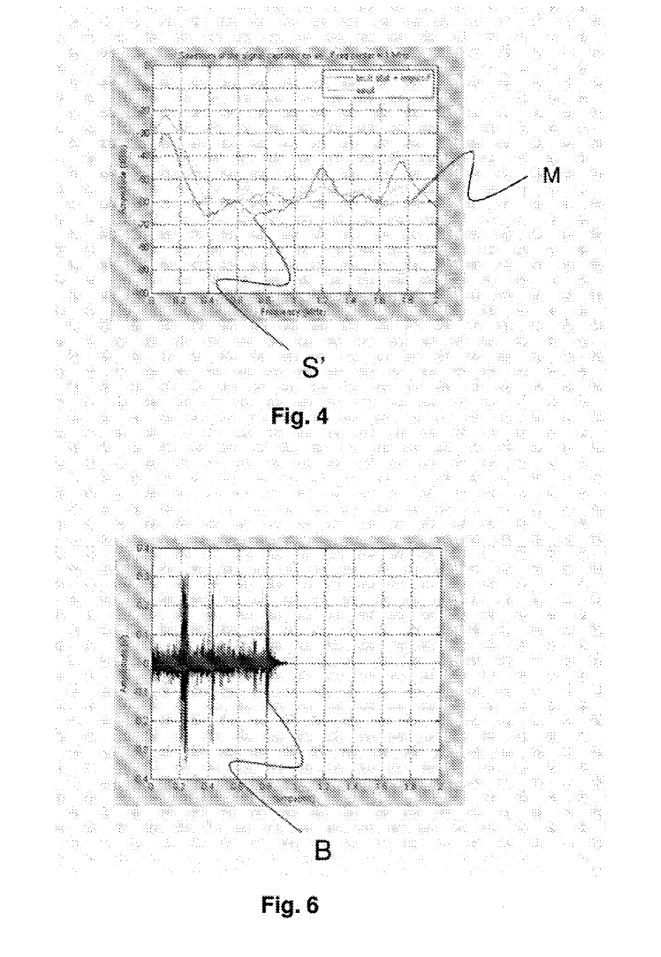

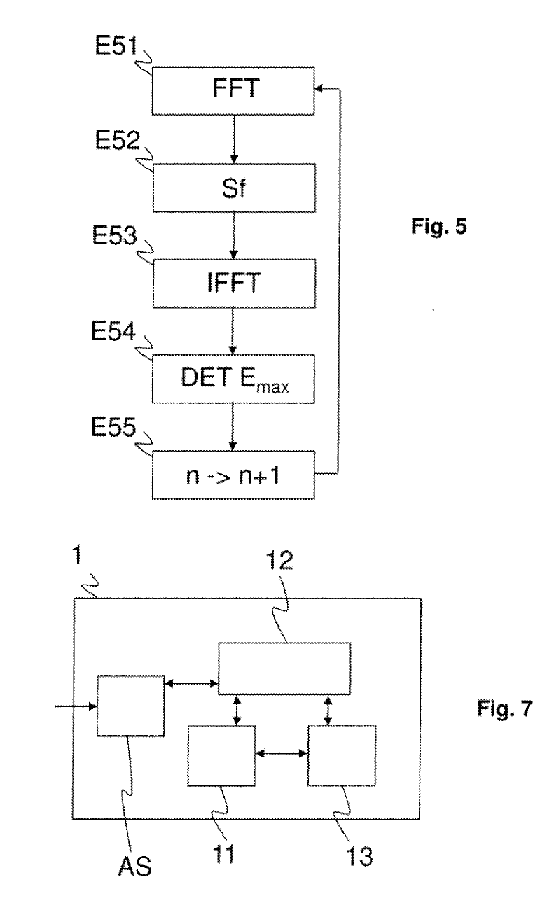

FIG. 4 is an example of a spectral representation of the stored signal S″. In this example, the second signal S′ contains stationary noise, substantially identical to that in the first signal S shown in FIGS. 2 and 3, and an impulse noise that results in two peaks. At low frequencies, the signal S′ is substantially identical to the signal S, but it differs therefrom by the two peaks that are located at high frequencies. The amplitude of the two peaks is smaller than the maximum amplitude of the signal S′ but is higher than that of the mask M at the frequencies of these peaks, and there is therefore spectral detection of the presence of impulse noise by means of the stored signal S″, because of these two peaks.

In the following step E5, the stored signal S″ is processed after spectral detection of the presence of the impulse noise. The stored signal S″ is a time-domain signal the duration of which is 2 ms. It comprises five acquisition frames, each of 1024 samples. A real-time spectrum analyzer typically works with frames of 1024 samples but of course the invention is not limited to this embodiment.

The processing comprises substeps E51 to E55:

In step E51, a frame of 1024 samples is considered and the fast Fourier transform (FFT) is computed. The result is a signal in the frequency domain.

The following step E52 is a high-pass filtering of the signal obtained in the preceding step. The high-pass filtering has the objective of removing the lower portion of the spectrum, in which portion the signal has an amplitude higher than that of the rest of the spectrum. This low portion of the spectrum masks the impulse noise.

The result is a filtered signal Sf with its low frequencies removed.

The following step E53 is the computation of the inverse Fourier transform of the signal filtered beforehand, so as to obtain a representation of the filtered signal in the time domain.

The following step E54 is the definition of the maximum energy Eₘₐₓ. In the first iteration, this maximum is the norm of the result vector of the inverse Fourier transform. In subsequent iterations, the maximum is the largest value between the norm of the result vector of the inverse Fourier transform and the maximum defined in the preceding iteration. Defining the maximum energy Eₘₐₓ allows the amplitude of the signal to be determined at a time t and therefore the envelope of the impulse noise signal to be reconstructed in the time domain.

The following step E55 is a passage to the following frame of the stored signal, provided that all the frames have not already been processed. If at least one frame remains to be processed, step E55 is followed by step E51.

When all the frames have been processed, the processing of the signal is terminated.

The impulse noise is then detected and reconstructed. FIG. 6 shows an example impulse noise B extracted from the signal S′, which contained stationary noise and an impulse noise with an amplitude smaller than that of the stationary noise.

In practice, impulse noises are generated by household appliances, for example in a home. These impulse noises are then transmitted by electrical cables and may couple to telephone cables.

These impulse noises then interfere with transmissions of the xDSL or PLT type. For example, during reception of a television signal the quality of service (QoS) may be degraded, resulting in pixelization and “freezing” of the image.

Knowledge and characterization of impulse noises liable to interfere with useful signals make it possible for error correcting codes to be correctly dimensioned. For example, the interleaving delay and noise margin targeted for ADSL (both in the DSLAM and in the client modem) or even the FEC COP3 matrix for an RTP stream, may be defined depending on these impulse noises.

More generally, knowledge and characterization of impulse noises liable to interfere with useful signals make it possible for tests to be carried out on items of telecommunication hardware in order to select those that have the best behavior when subjected to interference representative of reality, and not just interference following theoretical models.

With reference to FIG. 7, a device 1 for measuring impulse noise in a signal comprises:

means for transforming the signal into the frequency domain;

means for defining a triggering threshold that is a function of frequency, depending on the stationary characteristics of the signal;

means for storing the signal in memory when the threshold is reached; and

means for high-pass filtering the stored signal.

The device 1 implements the steps described above. To do this, it comprises a real-time spectrum analyzer AS coupled to a piece of computing equipment, typically having the structure of a computer. The real-time spectrum analyzer AS receives the signal to be processed and carries out the steps of transforming, defining a triggering threshold, and storing the signal. The subsequent processing is carried out by the piece of computing equipment.

Such a piece of equipment comprises a memory 11 comprising a buffer memory; and a processing unit 12, for example equipped with a microprocessor and controlled by the computer program 13, implementing the method according to the invention.

On initialization, the coded instructions of the computer program 13 are for example loaded into a RAM memory before being executed by the processor of the processing unit 12. The processing unit 12 receives as input the signal stored by the real-time spectrum analyzer after triggering. The microprocessor of the processing unit 12 implements the steps of the method described above according to the instructions of the computer program 13 in order to measure the impulse noise in the signal.

1. A method for measuring impulse noise in a signal, wherein the method comprises steps of:
measuring at least one first signal;
transforming the first signal into the frequency domain;
defining a triggering threshold that varies as a function of frequency, depending on the stationary characteristics of the first signal;
measuring a second signal;
transforming the second signal into the frequency domain;
storing the second signal in memory when the second signal reaches or exceeds the triggering threshold; and
high-pass filtering the stored signal.

2. The method for measuring impulse noise in a signal as claimed in claim 1, wherein the transformation of the signal into the frequency domain is carried out via a Fourier transform.

3. The method for measuring impulse noise in a signal as claimed in claim 2, wherein the transformation of the signal into the frequency domain is carried out in a real-time spectrum analyzer.

4. The method for measuring impulse noise in a signal as claimed in claim 1, wherein the triggering threshold is defined from a measurement of stationary noise in the first signal.

5. The method for measuring impulse noise in a signal as claimed in claim 4, wherein the triggering threshold is a mask placed over the first signal.

6. The method for measuring impulse noise in a signal as claimed in claim 1, in which a plurality of first signals is measured and transformed into the frequency domain, the triggering threshold that varies as a function of frequency being defined depending on the average of the plurality of transformed first signals.

7. A device for measuring impulse noise in a signal, wherein the device comprises:
means for transforming the signal into the frequency domain, the transforming means being configured to measure at least one first signal and one second signal;
means for defining a triggering threshold that varies as a function of frequency, depending on stationary characteristics of the first signal;
means for storing the second signal in memory when the triggering threshold is reached or exceeded; and
means for high-pass filtering the stored signal.

8. (canceled)

9. A computer-readable recording medium on which a computer program is recorded and comprises instructions that configure a processor to execute a method for measuring impulse noise in a signal, wherein the method comprises:
measuring at least one first signal;
transforming the first signal into the frequency domain with the processor;
defining a triggering threshold that varies as a function of frequency, depending on stationary characteristics of the first signal;
measuring a second signal;
transforming the second signal into the frequency domain with the processor;
storing the second signal in memory when the second signal reaches or exceeds the triggering threshold; and
high-pass filtering the stored signal.
